(19) United States
(12) Patent Application Publication
(10) Pub. No.: US 2026/0218727 A1
(43) Pub. Date: Jul. 30, 2026

(54) BLOWER DEVICE AND METHOD FOR MANUFACTURING SAME

(71) Applicant: NIDEC CORPORATION, Kyoto (JP)

(72) Inventors: Yushi YAMASHITA, Kyoto (JP); Takeshi IBE, Kyoto (JP); Ryota HAYASHIDA, Kyoto (JP); Hidefumi KAWAKAMI, Kyoto (JP); Yuko HINO, Kyoto (JP)

(21) Appl. No.: 19/629,443

(22) Filed: Mar. 26, 2026

Related U.S. Application Data
(63) Continuation of application No. PCT/JP2024/033862, filed on Sep. 24, 2024.

(30) Foreign Application Priority Data
Sep. 29, 2023 (JP) 2023-169904

(51) Int. Cl. F04D 29/52; F04D 19/00; F04D 25/06; F04D 29/38

(52) U.S. Cl. CPC F04D 29/526; F04D 19/002; F04D 25/0613; F04D 29/38; F05D 2230/10

(57) ABSTRACT

A blower device includes a fan and a housing. The fan includes an impeller that is rotatable about a center axis. The housing accommodates the fan. The housing includes a tubular wall that extends along a center axis and covers the impeller from a radially outer side. The impeller includes a plurality of blades arranged in a circumferential direction. A cutting mark is provided on at least a portion of an inner circumferential surface of the tubular wall radially facing the blades or radially outer end portions of the blades.

### CROSS-REFERENCE TO RELATED APPLICATIONS

This application is a continuation of International Application No. PCT/JP2024/033862, filed on Sep. 24, 2024, which is incorporated herein by reference in its entirety, and which claims priority to Japanese Patent Application No. 2023-169904, filed in Japan on Sep. 29, 2023, the entire contents of each above-mentioned application being incorporated herein by reference.

### 1. FIELD OF THE INVENTION

The present disclosure relates to blower devices and methods for manufacturing the same.

### 2. BACKGROUND

A blower device in the related art includes a fan including an impeller that rotates about a center axis and a housing accommodating the fan. The housing includes a tubular wall extending along the center axis and covering the impeller from a radially outer side. The impeller includes a plurality of blades arranged in a circumferential direction.

However, in the blower device in the related art, the blades may be deformed by a centrifugal force during rotation and bulge radially outward. In this case, when a radial gap between the impeller and the housing is small, the impeller and the housing may come into contact with each other, and blowing performance of the blower device may be reduced. On the other hand, when the radial gap between the impeller and the housing is formed to be large, a blade tip vortex is likely to be generated, and the blowing performance of the blower device may be reduced.

### SUMMARY

A blower device according to an example embodiment of the present disclosure includes a fan and a housing. The fan includes an impeller that is rotatable about a center axis. The housing accommodates the fan. The housing includes a tubular wall. The tubular wall extends along the center axis and covers the impeller from a radially outer side. The impeller includes a plurality of blades arranged in a circumferential direction. A cutting mark is provided on at least a portion of an inner circumferential surface of the tubular wall radially facing the plurality of blades or radially outer end portions of the plurality of blades.

A method for manufacturing a blower device according to an example embodiment of the present disclosure is a method for manufacturing a blower device including a fan and a housing, and includes, in order, a mold-forming step and a cutting step. The fan includes an impeller configured to rotate about a center axis. The housing includes a tubular wall accommodating the fan and covering the impeller from a radially outer side. In the mold-forming step, the housing is mold-formed. In the cutting step, an inner circumferential surface of the tubular wall is cut. In the cutting step, the inner circumferential surface of the tubular wall is cut by rotating a cutting blade inserted into the tubular wall about the center axis.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is an overall perspective view of a blower device according to an example embodiment of the present disclosure.

FIG. 2 is a longitudinal cross-sectional view of a blower device according to an example embodiment of the present disclosure.

FIG. 3 is a longitudinal cross-sectional view of a housing of a blower device according to an example embodiment of the present disclosure.

FIG. 4 is a flowchart illustrating a manufacturing process of a housing of a blower device according to an example embodiment of the present disclosure.

FIG. 5 is an explanatory diagram illustrating a manufacturing process of a housing of a blower device according to an example embodiment of the present disclosure.

FIG. 6 is an explanatory diagram illustrating a manufacturing process of a housing of a blower device according to an example embodiment of the present disclosure.

FIG. 7 is an explanatory diagram illustrating a manufacturing process of a housing of a blower device according to an example embodiment of the present disclosure.

### DETAILED DESCRIPTION

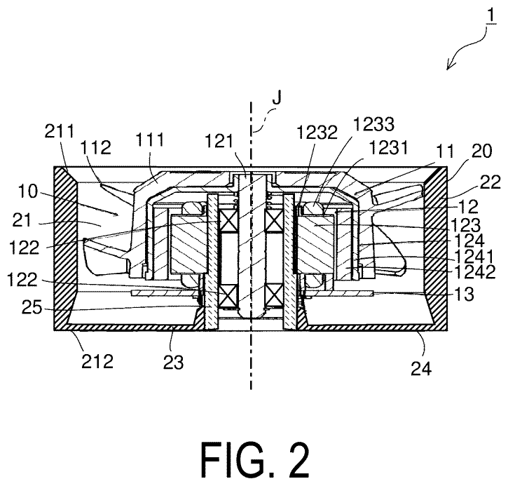

Example embodiments of the present disclosure will be described in detail below with reference to the drawings. Herein, a direction in which a center axis of a blower device extends is simply referred to as an “axial direction”, a direction orthogonal to the center axis with the center axis of the blower device as a center is simply referred to as a “radial direction”, and a direction along a circular arc centered on the center axis of the blower device is simply referred to as a “circumferential direction”. In addition, for ease of description, herein, the axial direction is defined as an up-down direction, and the up-down direction in FIG. 2 is defined as an up-down direction of the blower device to describe the shape and positional relationship of each portion. An “upper side” of the blower device is an “intake side”, and a “lower side” thereof is an “exhaust side”. Note that the definition of the up-down direction does not limit the orientation and positional relationship of the blower device during use. Herein, a cross section parallel to the axial direction is referred to as a “longitudinal cross section”. In addition, as used herein, the term “parallel” does not necessarily indicate parallel in a strict sense, and includes substantially parallel.

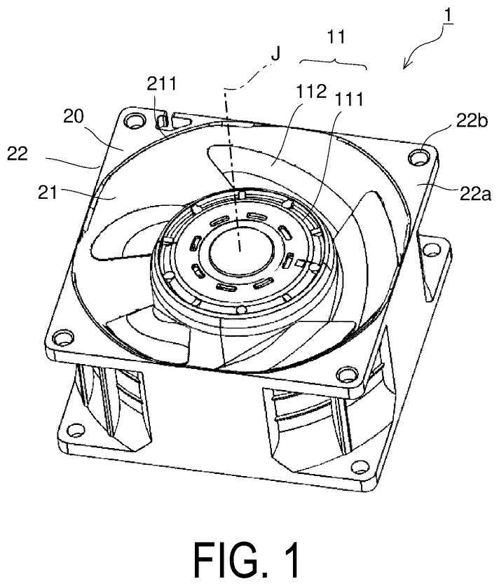

FIG. 1 is an overall perspective view of an example of a blower device 1 according to an example embodiment of the present disclosure, and FIG. 2 is a longitudinal cross-sectional view of the blower device 1. Note that, in FIG. 2, flange portions 22a are omitted.

The blower device 1 includes a fan 10 and a housing 20. The fan 10 includes an impeller 11 and a motor 12.

The housing 20 includes an air flow path 21 therein. The air flow path 21 extends along a center axis J inside the housing 20. The air flow path 21 includes an intake port 211 at an upper end and an outlet port 212 at a lower end.

The housing 20 is a resin-molded product (molded product) and accommodates the impeller 11, the motor 12, and a circuit board 13 therein. The housing 20 includes a tubular wall 22, a base portion 23, a connecting portion 24, and a bearing holding portion 25.

The tubular wall 22 extends along the center axis J and covers the impeller 11 from a radially outer side. The tubular wall 22 has a cylindrical shape extending vertically in the axial direction. The air flow path 21 is disposed inside the tubular wall 22 in the radial direction. The intake port 211 is disposed at an upper end, in the axial direction, of the tubular wall 22. The outlet port 212 is disposed at a lower end, in the axial direction, of the tubular wall 22. In addition, the tubular wall 22 includes flange portions 22a disposed at corner portions of the upper end portion and the lower end portion (see FIG. 1). The flange portion 22a includes an attachment hole 22b extending therethrough in the axial direction. The blower device 1 may be screw-fastened to a mounted surface via the attachment hole 22b.

The base portion 23 is disposed on a lower side in the axial direction of the motor 12. The base portion 23 to which the motor 12 is fixed has a disk shape extending in the radial direction about the center axis J. The connecting portion 24 extends radially outward from a radially outer surface of the base portion 23 and connects the base portion 23 and the tubular wall 22. A plurality of the connecting portions 24 are arranged in the circumferential direction. The air flowing through the air flow path 21 passes between adjacent connecting portions 24.

The bearing holding portion 25 is, for example, a metal member made of a metal such as brass, and is integrally molded with the base portion 23. The bearing holding portion 25 protrudes axially upward from an upper surface of the base portion 23 and has a cylindrical shape centered on the center axis J. The bearing holding portion 25 holds a bearing 122 (described below) therein and constitutes a portion of the motor 12. Note that the bearing holding portion 25 may be molded integrally with the base portion 23 by resin molding, instead of being molded as a separate member from the base portion 23.

The impeller 11 is disposed on a radially inner side of the tubular wall 22 and on an axially upper side and a radially outer side of the motor 12. The impeller 11 is a resin-molded product (molded product) and is rotated about the center axis J by the motor 12.

The impeller 11 includes an impeller cup 111 and blades 112. The impeller cup 111 is fixed to the motor 12. The impeller cup 111 is a substantially cylindrical member including a lid on an axially upper side. The plurality of blades 112 are arranged in the circumferential direction on an outer surface of the impeller cup 111.

The motor 12 is fixed to the base portion 23 and accommodated in the housing 20. The motor 12 rotates the impeller 11 about the center axis J. The motor 12 includes a shaft 121, a bearing 122, the bearing holding portion 25, a stator 123, and a rotor 124.

The shaft 121 is disposed along the center axis J. The shaft 121 is a columnar member made of a metal such as stainless steel and extending vertically in the axial direction. The shaft 121 is supported by the bearing 122 so as to be rotatable about the center axis J.

At least a pair of bearings 122 are disposed vertically in the axial direction. The bearings 122 are held on an inner side of the bearing holding portion 25. For example, the bearings 122 are constituted by ball bearings, but may be constituted by sleeve bearings or the like. The pair of bearings 122 arranged vertically in the axial direction supports the shaft 121 so as to be rotatable about the center axis J with respect to the housing 20.

The stator 123 is fixed to an outer circumferential surface of the bearing holding portion 25. The stator 123 includes a stator core 1231, an insulator 1232, and a coil 1233.

The stator core 1231 is formed by vertically stacking electromagnetic steel plates such as silicon steel plates. The insulator 1232 is made of a resin having insulating properties. The insulator 1232 is provided to surround an outer surface of the stator core 1231. The coil 1233 is formed of a conductive wire wound around the stator core 1231, with the insulator 1232 interposed therebetween.

The rotor 124 is disposed on an axially upper side and a radially outer side of the stator 123. The rotor 124 rotates about the center axis J with respect to the stator 123. The rotor 124 includes a rotor yoke 1241 and a magnet 1242.

The rotor yoke 1241 is a substantially cylindrical member made of a magnetic material and including a lid on an axially upper side. The rotor yoke 1241 is fixed to the shaft 121. The magnet 1242 has a cylindrical shape and is fixed to an inner circumferential surface of the rotor yoke 1241. The magnet 1242 is disposed on a radially outer side of the stator 123.

The circuit board 13 is disposed on an axially lower side of the impeller 11 and on an axially upper side of the base portion 23. The circuit board 13 has, for example, a disk shape extending radially and centered on the center axis J. A lead wire of the coil 1233 is electrically connected to the circuit board 13. An electronic circuit for supplying a drive current to the coil 1233 is mounted on the circuit board.

In the blower device 1 configured as described above, when a drive current is supplied to the coil 1233 of the motor 12 via the circuit board 13, a magnetic flux in the radial direction is generated in the stator core 1231. A magnetic field generated by the magnetic flux in the stator core 1231 and a magnetic field generated by the magnet 1242 interact to generate torque in the circumferential direction of the rotor 124. The torque causes the rotor 124 and the impeller 11 to rotate about the center axis J. When the impeller 11 rotates, an air flow is generated by the plurality of blades 112. That is, the blower device 1 can perform air blowing by generating an air flow with the upper side as the intake side and the lower side as the exhaust side.

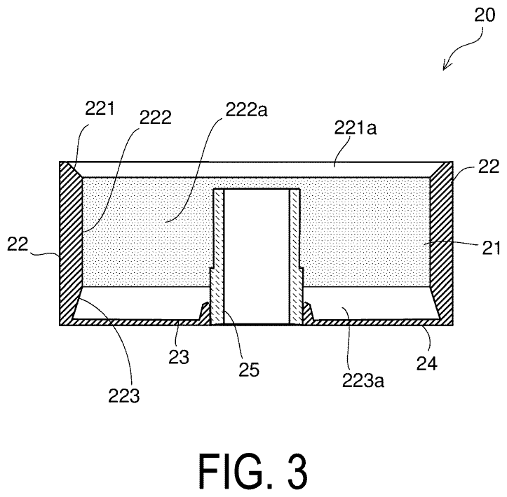

FIG. 3 is a longitudinal cross-sectional view of the housing 20. Note that, in FIG. 3, a cutting mark 222a is indicated by a dotted pattern for the sake of explanation. In addition, in FIG. 3, the flange portions 22a are omitted.

The tubular wall 22 of the housing 20 includes enlarged-diameter portions 221 and 223 and a constant-diameter portion 222. The constant-diameter portion 222 has a constant inner diameter and extends in the axial direction (parallel to the center axis J). The enlarged-diameter portions 221 and 223 are disposed adjacent to both axial sides (an axially upper side and an axially lower side) of the constant-diameter portion 222, respectively, and have inner diameters that increase with increasing distance from the constant-diameter portion 222 in the axial direction. As a result, inner circumferential surfaces of the enlarged-diameter portions 221 and 223 are inclined radially outward as they extend axially outward.

An inner circumferential surface of the constant-diameter portion 222 has a cutting mark 222a. The inner circumferential surface of the enlarged-diameter portion 221 has an unmachined surface 221a without the cutting mark 222a. The inner circumferential surface of the enlarged-diameter portion 223 has an unmachined surface 223a. That is, the cutting mark 222a is located on the inner circumferential surface of the constant-diameter portion 222. As a result, the cutting mark 222a is located at a radially inner end portion on an inner circumferential surface of the tubular wall 22.

In addition, the unmachined surfaces 221a and 223a are located on the inner circumferential surfaces of the enlarged-diameter portions 221 and 223, respectively. That is, the housing 20 has the unmachined surfaces 221a and 223a without the cutting mark 222a.

As a result, the cutting mark 222a is formed on at least a portion of the inner circumferential surface of the tubular wall 22 radially facing the blades 112. In the present example embodiment, the cutting mark 222a extends over the entire portion in the circumferential direction on the inner circumferential surface of the tubular wall 22. Here, the cutting mark 222a may extend continuously over the entire portion in the circumferential direction, may extend intermittently over a continuous portion in the circumferential direction, or may extend continuously only over a portion in the circumferential direction on the inner circumferential surface of the tubular wall 22. When the cutting mark 222a extends continuously over the entire portion in the circumferential direction on the inner circumferential surface of the tubular wall 22, cutting is performed over the entire portion in the circumferential direction, and thus variation of an inner diameter of the cutting mark 222a can be reduced. When the cutting mark 222a extends intermittently over a continuous portion in the circumferential direction on the inner circumferential surface of the tubular wall 22, a cutting amount of the cutting mark 222a can be reduced, a cutting time for forming the cutting mark 222a can be reduced, and wear of cutting blades 71a can be reduced.

The cutting mark 222a is formed by subjecting a surface of the mold-formed housing 20 to cutting processing. The unmachined surfaces 221a and 223a are surfaces that were in contact with a mold during mold-forming, and have not been subjected to cutting processing.

By subjecting the constant-diameter portion 222 to cutting processing, variation of the inner diameter of the constant-diameter portion 222 can be reduced with respect to dimensional variation of the mold-formed housing 20. Therefore, a gap with a predetermined width is reliably ensured between the blades 112 and the tubular wall 22. As a result, contact between the impeller 11 and the housing 20 can be prevented. Accordingly, a decrease in airflow rate and static pressure of the blower device 1 can be prevented, thereby preventing deterioration of blowing performance.

Note that, by reducing the minimum radial distance between the tubular wall 22 and the blades 112, occurrence of a blade tip vortex can be suppressed, and the airflow rate and static pressure of the blower device 1 can be improved. As a result, the blowing performance of the blower device 1 can be further improved.

In addition, the region where the cutting mark 222a is formed has reduced surface roughness, allowing airflow to smoothly flow in the axial direction. As a result, the airflow rate and static pressure of the blower device 1 can be further improved.

By forming the cutting mark 222a over the entire portion in the circumferential direction on the inner circumferential surface of the tubular wall 22, the airflow rate and static pressure of the blower device 1 can be further improved. In addition, contact between the impeller 11 and the housing 20 can be further prevented.

Note that, in the present example embodiment, the cutting mark 222a is formed on the entire surface of the constant-diameter portion 222, but may be formed only on a portion thereof. Although depending on the shape of the tubular wall 22, when the cutting mark 222a is formed at a radially inner end portion of the tubular wall 22, contact between the impeller 11 and the housing 20 can be prevented.

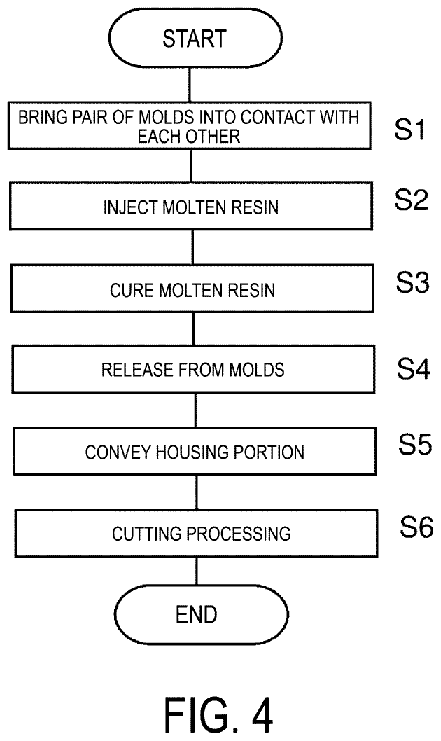

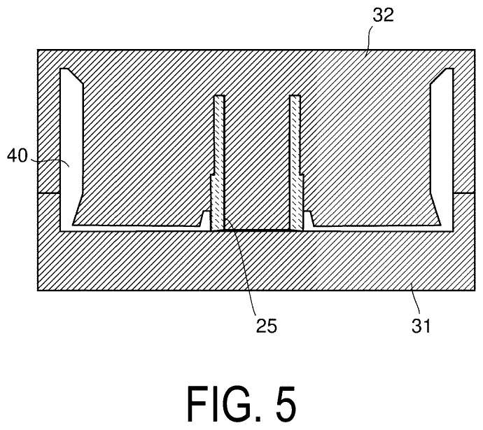

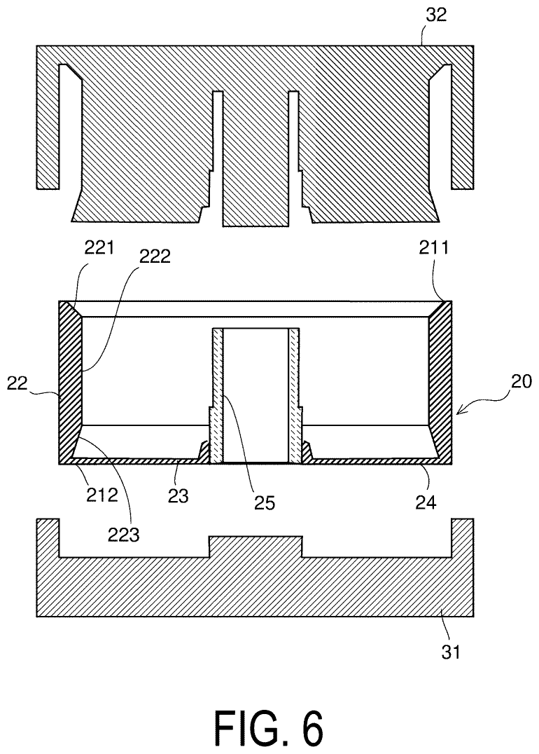

FIG. 4 is a flowchart illustrating a manufacturing process of the housing 20. FIGS. 5, 6, and 7 are explanatory diagrams illustrating the manufacturing process of the housing 20. Note that, in FIGS. 5 and 6, the flange portions 22a are omitted.

In step S1, as illustrated in FIG. 5, a peripheral edge portion of a mold 31 and a peripheral edge portion of a mold 32 are brought into contact with each other in the up-down direction, thereby forming a cavity 40 between the mold 31 and the mold 32. The cavity 40 has a shape corresponding to a shape of the housing 20. In addition, the bearing holding portion 25 is disposed at a position of the cavity 40 corresponding to the base portion 23.

In step S2, a molten resin is injected into the cavity 40. In step S3, the resin is cooled and cured. As a result, the housing 20 is formed in the cavity 40. At this time, the base portion 23 and the bearing holding portion 25 are integrally formed. In step S4, as illustrated in FIG. 6, the housing 20 is released from the pair of molds 31 and 32. At this time, the entire surface of the housing 20 is an unmachined surface without a cutting mark 222a.

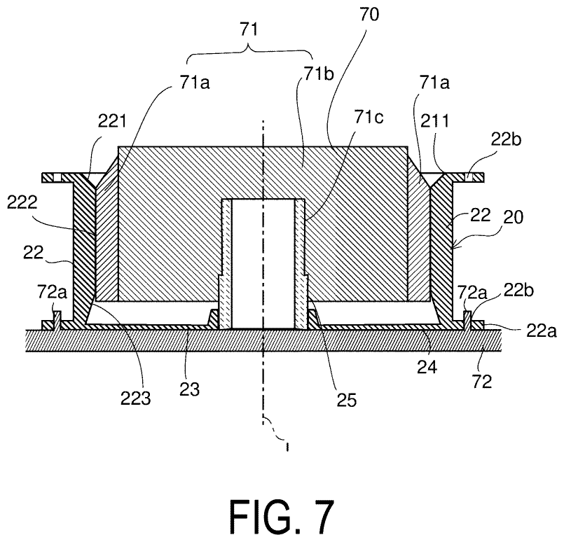

In step S5, as illustrated in FIG. 7, the housing 20 is conveyed to a cutting device 70. The cutting device 70 includes a cutting unit 71 and a table 72. The cutting unit 71 includes a cutting blade 71a and a rotating body 71b. The rotating body 71b has a cylindrical shape and is rotatable about the center axis J. Additionally, the rotating body 71b has an insertion hole 71c extending axially upward from a lower surface. A plurality of the cutting blades 71a are fixed to an outer circumferential surface of the rotating body 71b in a circumferential direction.

The table 72 has an upper surface orthogonal to the axial direction, and the conveyed housing 20 is placed thereon. The table 72 includes pins 72a protruding axially from the upper surface thereof. The pins 72a are inserted into the attachment holes 22b of the housing 20. As a result, the housing 20 can be positioned on the table 72.

The cutting unit 71 is inserted into the tubular wall 22 after the housing 20 is disposed on the table 72. At this time, the bearing holding portion 25 is inserted into the insertion hole 71c. As a result, the rotating body 71b can be inserted into the tubular wall 22 without coming into contact with the bearing holding portion 25.

Thereafter, the rotating body 71b rotates about the center axis J, and the cutting blades 71a rotate about the center axis J. As a result, the inner circumferential surface of the tubular wall 22 is cut by the cutting blades 71a.

In step S6, the cutting blades 71a are rotated about the center axis J to cut the inner circumferential surface of the tubular wall 22. As a result, the cutting mark 222a is formed on the inner circumferential surface of the constant-diameter portion 222. By rotating the cutting blades 71a about the center axis J to form the cutting mark 222a, the cutting mark 222a extending over the entire portion in the circumferential direction can be readily formed on the inner circumferential surface of the tubular wall 22.

As described above, the method for manufacturing the housing 20, which is a part of the housing of the blower device 1, includes, in order, a mold-forming step, a conveying step, and a cutting step. In the mold-forming step, the housing 20 is mold-formed from a resin (steps S1 to S4). In the conveying step, the housing 20 formed in the mold-forming step is conveyed, and the cutting blades 71a are inserted into the tubular wall 22 (step S5). In the cutting step, the cutting blades 71a inserted into the tubular wall 22 are rotated about the center axis J to cut the inner circumferential surface of the tubular wall 22 (step S6). The conveying step enables the cutting step to be performed continuously after the mold-forming step, thereby improving manufacturing efficiency of the housing 20.

Note that, in the present example embodiment, the cutting mark 222a is formed by the cutting blades 71a, but the cutting mark 222a may be formed by using an abrasive instead of the cutting blades 71a.

The above-described example embodiments are merely illustrative of the present disclosure. The configuration of the example embodiment may be appropriately changed without departing from the technical idea of the present disclosure. Furthermore, the example embodiments may be combined with each other within a feasible range. For example, in the present example embodiment, the cutting mark 222a is formed on the inner circumferential surface of the tubular wall 22, but the cutting mark may be formed at radially outer end portions of the blades 112. By subjecting the radially outer end portions of the blades 112 to cutting processing, variation of outer diameters of the blades 112 can be reduced with respect to dimensional variation of the mold-formed blades 112. Therefore, a gap with a predetermined width is reliably ensured between the blades 112 and the tubular wall 22. As a result, contact between the impeller 11 and the housing 20 can be prevented. Accordingly, a decrease in airflow rate and static pressure of the blower device 1 can be prevented, thereby preventing deterioration of blowing performance. Note that a region other than the radially outer end portions of the blades 112 is an unmachined surface without a cutting mark.

In this case, the cutting mark is preferably formed at the radially outer end portions of all the blades 112. As a result, contact between the impeller 11 and the housing 20 can be prevented.

As described above, a blower device (1) according to one aspect of the present disclosure includes a fan (10) including an impeller (11) configured to rotate about a center axis (J) and a housing (20) accommodating the fan, wherein the housing includes a tubular wall (22) extending along the center axis and covering the impeller from a radially outer side, the impeller includes a plurality of blades (112) arranged in a circumferential direction, and a cutting mark (222a) is formed on at least a portion of an inner circumferential surface of the tubular wall radially facing the plurality of blades or radially outer end portions of the plurality of blades (first configuration).

In addition, in the first configuration, the housing and the impeller are mold-formed products and include unmachined surfaces (221a, 223a) without the cutting mark, and the cutting mark has a surface roughness less than a surface roughness of the unmachined surfaces (second configuration).

In addition, in the first or second configuration, the cutting mark is located at a radially inner end portion on the inner circumferential surface of the tubular wall (third configuration).

In addition, in any one of the first to third configurations, the cutting mark extends over an entire portion in the circumferential direction on the inner circumferential surface of the tubular wall (fourth configuration).

In addition, in any one of the first to fourth configurations, the cutting mark is formed at the radially outer end portions of all the plurality of blades (fifth configuration).

In addition, in any one of the first to fifth configurations, the tubular wall includes a constant-diameter portion (222) having a constant inner diameter and extending in an axial direction and enlarged-diameter portions (221, 223) disposed adjacent to both axial sides of the constant-diameter portion and having inner diameters that increase with increasing distance from the constant-diameter portion (222) in the axial direction, the cutting mark is located on an inner circumferential surface of the constant-diameter portion, and the unmachined surfaces are located on inner circumferential surfaces of the enlarged-diameter portions (sixth configuration).

Further, a method for manufacturing a blower device (1) according to one aspect of the present disclosure is a method for manufacturing a blower device including a fan (10) including an impeller (11) configured to rotate about a center axis (J) and a housing (20) including a tubular wall (22) accommodating the fan and covering the impeller from a radially outer side, the method including, in order, a mold-forming step of mold-forming the housing and a cutting step of cutting an inner circumferential surface of the tubular wall, wherein in the cutting step, the inner circumferential surface of the tubular wall is cut by rotating a cutting blade (71a) inserted into the tubular wall about the center axis (seventh configuration).

In addition, in the seventh configuration, the method further includes a conveying step of conveying the housing mold-formed in the mold-forming step and inserting the cutting blade into the tubular wall (eighth configuration).

The present disclosure is applicable, for example, to a blower device for cooling a personal computer.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A blower device comprising:
a fan including an impeller rotatable about a center axis; and
a housing accommodating the fan; wherein
the housing includes a tubular wall extending along the center axis and covering the impeller from a radially outer side;
the impeller includes a plurality of blades arranged in a circumferential direction; and
a cutting mark is provided on at least a portion of an inner circumferential surface of the tubular wall radially facing the plurality of blades or radially outer end portions of the plurality of blades.

2. The blower device according to claim 1, wherein
the housing and the impeller are mold-formed products and include unmachined surfaces without the cutting mark; and
the cutting mark has a surface roughness less than a surface roughness of the unmachined surfaces.

3. The blower device according to claim 1, wherein the cutting mark is located at a radially inner end portion on the inner circumferential surface of the tubular wall.

4. The blower device according to claim 1, wherein the cutting mark extends over an entire portion in a circumferential direction on the inner circumferential surface of the tubular wall.

5. The blower device according to claim 1, wherein the cutting mark is provided at the radially outer end portions of all the plurality of blades.

6. The blower device according to claim 2, wherein
the tubular wall includes a constant-diameter portion having a constant inner diameter and extending in an axial direction and enlarged-diameter portions adjacent to both axial sides of the constant-diameter portion and having inner diameters that increase with increasing distance from the constant-diameter portion in the axial direction;
the cutting mark is located on an inner circumferential surface of the constant-diameter portion; and
the unmachined surfaces are located on inner circumferential surfaces of the enlarged-diameter portions.

7. A method for manufacturing a blower device including a fan including an impeller configured to rotate about a center axis and a housing including a tubular wall accommodating the fan and covering the impeller from a radially outer side, the method comprising, in order:
mold-forming the housing; and
cutting an inner circumferential surface of the tubular wall; wherein
wherein in the cutting, the inner circumferential surface of the tubular wall is cut by rotating a cutting blade inserted into the tubular wall about the center axis.

8. The method for manufacturing a blower device according to claim 7, further comprising conveying the housing mold-formed in the mold-forming and inserting the cutting blade into the tubular wall.
